(19) United States
(12) Patent Application Publication
(10) Pub. No.: US 2026/0250590 A1
(43) Pub. Date: Aug. 27, 2026

(54) METHOD FOR MANUFACTURING COMBUSTION AID FOR ADDITION BEFORE FOSSIL FUEL COMBUSTION AND DESULFURIZATION CATALYST

(71) Applicant: Won Bang HONG, Seoul (KR)

(72) Inventors: Won Bang HONG, Seoul (KR); Moo Shin PARK, Yangju-si (KR); Jeong Hwan HONG, Seoul (KR)

(21) Appl. No.: 18/994,117

(22) PCT Filed: May 10, 2023
(86) PCT No.: PCT/KR2023/006333

§ 371 Date: Jan. 14, 2025

(30) Foreign Application Priority Data
Jul. 20, 2022 (KR) 10-2022-0089271

(51) Int. Cl. C10L 10/02; B01D 53/86

(52) U.S. Cl. CPC C10L 10/02; B01D 53/8603; B01D 2257/30; C10L 2200/029; C10L 2230/04; C10L 2250/04; C10L 2270/02

(57) ABSTRACT

The present invention relates to a method for manufacturing a combustion aid for addition before fossil fuel combustion and a desulfurization catalyst, the method comprising the steps of: (S10) injecting illite powder into a reaction tank in which water heated to 40-100° C. is stored, and stirring; (S20) injecting sodium hydroxide into the reaction tank and stirring; (S30) preparing a desulfurization catalyst by separating and filtering a supernatant in the reaction tank; and (S40) preparing a combustion aid by separating a precipitate from the reaction tank.

### TECHNICAL FIELD

The present invention relates to a manufacturing method for simultaneously manufacturing a combustion aid and a desulfurization catalyst added before combustion of fossil fuels.

### BACKGROUND ART

Recently, environmental destruction on a global scale has become an extremely serious problem. Particularly when nitrogen oxides (NOx) or sulfur oxides (SOx) subject to the combustion of fossil fuels such as petroleum or coal are emitted into the atmosphere, these substances become acid rain, acid fog or the like, thereby significantly destroying the environment, such as forests and lakes.

In addition, when particulates (particulate matter such as soot, dust, and mist) scattered into the atmosphere are absorbed along with SOx and NOx as well as combustion exhaust gas, a negative effect is exerted on the human body. Therefore, it is necessary to take measures to prevent pollutants such as SOx, NOx, and particulates from being emitted into the atmosphere as possible.

As a measure to reduce SOx emissions, a scheme using post-treatment after combustion, that is, flue gas desulfurization, has been proposed. The flue gas desulfurization scheme refers to the desulfurization of flue gas after burning fossil fuel containing sulfur gas, and the flue gas desulfurization scheme may be divided into a wet scheme and a dry scheme.

The wet scheme refers to a scheme of removing sulfur oxides by washing the exhaust gas through ammonia water, sodium hydroxide solution, lime milk and the like, and the dry scheme is a scheme of removing sulfur oxides by contacting particles or powders such as activated carbon or carbonate with exhaust gas to allow sulfur dioxides to be adsorbed or reacted.

Meanwhile, in order to use the flue gas desulfurization scheme, a desulfurization facility for processing exhaust gas is required to be separately built, the desulfurization facility requires a lot of manpower and costs to operate, and the desulfurization process is complex.

### DISCLOSURE

### Technical Problem

In order to solve the above problems, the present invention provides a manufacturing method for simultaneously manufacturing a desulfurization catalyst and a combustion promoter simultaneously added together with combustible materials without additional desulfurization facility to enable economical desulfurization.

### Technical Solution

A method for manufacturing a combustion aid added before fossil fuel combustion and a desulfurization catalyst (hereinafter referred to as “a manufacturing method of the present invention”) according to the present invention to achieve the above-mentioned object includes the steps of: (S10) introducing an illite powder into a reaction tank storing water heated to 40° C. to 100° C., followed by stirring; (S20) introducing sodium hydroxide into the reaction tank, followed by stirring; (S30) preparing a desulfurization catalyst by separating and filtering a supernatant in the reaction tank; and (S40) preparing a combustion aid by separating a precipitate from the reaction tank.

As an example, step S20 includes adding sodium tetraborate to the reaction tank.

As an example, step S20 includes adding water glass to the reaction tank.

As an example, step S20 includes adding hydrogen peroxide to the reaction tank.

As an example, step S40 includes mixing an additive including a surfactant and an oxyacid into the combustion aid.

As an example, step S40 includes mixing precipitated carbonate into the combustion aid.

As an example, step S30 includes mixing hydroxylpropyl methyl cellulose-based powder to a desulfurization catalyst.

### Advantageous Effects

As described above, according to the producing method of the present invention, the desulfurization catalyst and the combustion aid simultaneously added together with combustible materials without additional desulfurization facility so as to be economically desulfurized can be simultaneously manufactured.

### DESCRIPTION OF DRAWINGS

FIG. 1 is a block diagram showing a producing method of the present invention.

FIG. 2 is a graph showing an experimental result on the removal of sulfur oxides.

FIG. 3 is a graph showing an experimental result on a combustion aid efficiency.

### BEST MODE

### Mode for Invention

Hereinafter, preferred embodiments according to the present invention will be described in detail.

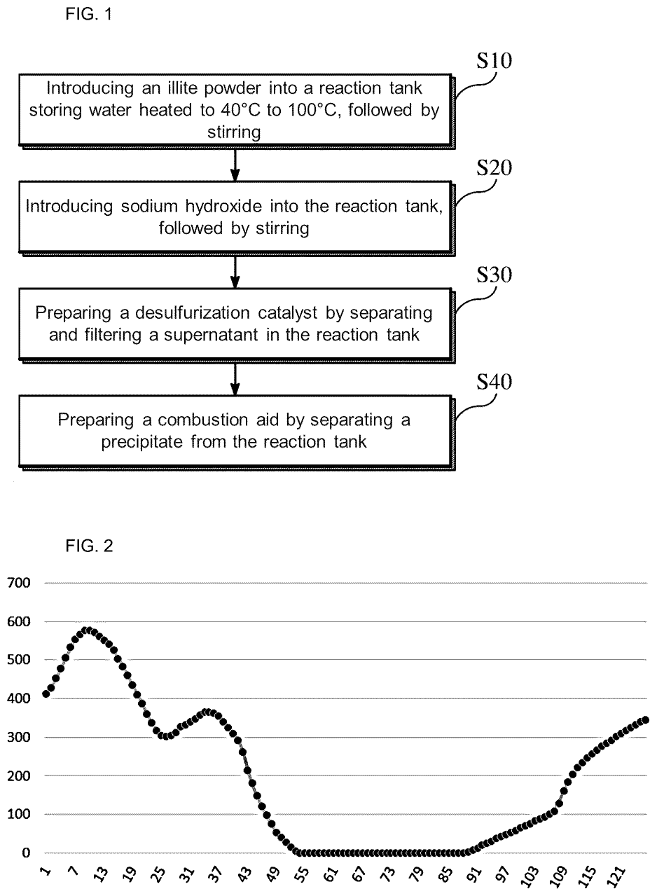

As shown in FIG. 1, the producing method of the present invention includes the steps of: (S10) introducing an illite powder into a reaction tank storing water heated to 40° C. to 100° C., followed by stirring; (S20) introducing sodium hydroxide into the reaction tank, followed by stirring; (S30) preparing a desulfurization catalyst by separating and filtering a supernatant in the reaction tank; and (S40) preparing a combustion aid by separating a precipitate from the reaction tank.

First, step S10 includes introducing an illite powder into a reaction tank storing water heated to 40° C. to 100° C., followed by stirring.

An illite extract is obtained through step S10, in which the illite is a mineral that is expressed as {K_{0.75}[Al_{1.75}(Mg·Fe₂₊)_{0.25}](Si_{3.50}Al_{0.50})O₁₀(OH)₂} and has been found to be buried in large quantities in the Yeongdong region of South Korea. A layer charge is lower compared to muscovite, and the charge is due to the isomorphous substitution decrease of Al³⁺ and Si⁴⁺ in a tetrahedral plate. The isomorphic substitution slightly occurs in an octahedral plate.

Illite is non-expandable due to the strong bonding force caused by K+ present between layers, and an interlayer spacing is 10 Å.

Thus, illite is a mineral extracted from a liquid state so as to be fully charged with positive ions and easily converted into a chelation-bonding compound. In the present invention, it is reasonable to use undifferentiated illite to easily extract the above metal foreign substance.

The extract extracted from illite is a liquid extract containing several kinds of metal oxides such as potassium oxide to provide a mineral easily converted into a chelation-bonding compound in a liquid state so as to serve as a reaction promoter in the absorption reaction of sulfur oxide in a sodium hydroxide aqueous solution described later.

In other words, during absorption of SOx in the sodium hydroxide aqueous solution, the illite extract is further added, so that the absorption efficiency may increase. Next, it includes a step (S20) of introducing sodium hydroxide into the reaction tank, followed by stirring.

In this manner, the illite extract is mixed into the sodium hydroxide aqueous solution. The sodium hydroxide aqueous solution has a feature of simultaneously removing high temperature, high concentration mixed gas containing COS (hydrocarbons, O₂ and SOx). In other words, the sodium hydroxide aqueous solution is added before combustion of fossil fuels so as to increase the removal rate of sulfur oxides (SOx) from exhaust gas.

The principle that sulfur oxides is removed by the sodium hydroxide aqueous solution is as shown in the following reaction formula. In other words, sulfur trioxide (sulfurous acid) and sulfur dioxide are removed when being reacted with sodium hydroxide and extracted into anhydrous sodium sulfate and sodium sulfite, respectively, as shown below.

In addition, the generated sodium carbonate may be reacted with excess sulfur oxides to further increase the removal effect of sulfur oxides.

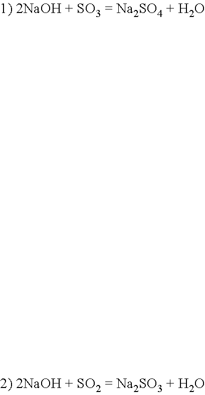

In addition, as mentioned above, the reaction formula of sodium hydroxide and the illite extract as a reaction promoter is as follows.

Only the main ingredients of Illite are described, and oxides of other trace ingredients such as Ca, Fe, Mg, Mn, Ti and P₂O₅ also contribute significantly to the formation of stable metal chelation compounds in the liquid state.

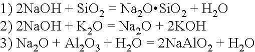

In addition, according to the present invention, step S20 further includes an example of adding sodium tetraborate to the reaction tank, followed by stirring.

In addition, step S20 further includes an example of adding water glass to the reaction tank, followed by stirring.

In other words, an example further includes adding sodium tetraborate (Na₂B₄O₇·10H₂O) and water glass (Na₂SiO₃) to the illite extract and the sodium hydroxide aqueous solution.

The sodium tetraborate and the water glass are added to the sodium hydroxide aqueous solution in addition to the illite extract.

Because the sodium tetraborate and the water glass are added in the above manner and the desulfurization catalyst ingredient is reacted directly, the reaction rate becomes much faster and the mass transfer coefficient also increases.

Further, because the sodium tetraborate and the water glass have high viscosity, absorbed sulfur oxide in a gaseous state fails to escape and quickly dissolves into a liquid state, thereby doubling the desulfurization efficiency.

In addition, according to the present invention, step S20 further includes an example of adding hydrogen peroxide to the reaction tank, followed by stirring. In other words, an example is presented in which hydrogen peroxide (H₂O₂) is further added as a reaction-promoting additive.

The reaction formula of sodium tetraborate and hydrogen peroxide in the sodium hydroxide aqueous solution is as follows.

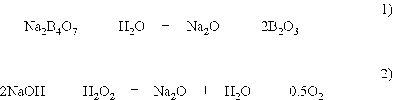

After the reaction is completed in the above manner, a next step (S30), of separating and filtering the supernatant from the reaction tank to manufacture a desulfurization catalyst, proceeds. The supernatant is separated from the reaction tank, and foreign substances contained in the supernatant are removed, so that a desulfurization catalyst is manufactured.

The desulfurization catalyst manufactured in the above manner may be used as a fuel-added desulfurization catalyst before combustion. As seen in the experiment below, it can be seen that the liquid desulfurization catalyst manufactured in the above manner exhibits fuel desulfurization ability.

Next, a step (S40), of preparing a combustion aid by separating a precipitate from the reaction tank, proceeds. The combustion aid is prepared by separating the precipitate. As seen in the experiment below, it can be seen that the combustion aid prepared in the above manner has the combustion efficiency based on the experimental results showing that the amount of CO₂ generated in the exhaust gas increases from 14% more or less to 17% under the same combustion conditions.

In addition, the present invention provides an example including mixing an additive including a surfactant and an oxyacid into the combustion aid prepared in step S40 to double the combustion efficiency.

The above separated precipitate, that is, the metal salt aqueous solution, is configured to contain the additive including the surfactant and the oxyacid.

The surfactant serves as a dispersant so that the combustion aid has a large surface area, and it is preferable to use a nonionic surfactant.

The nonionic surfactant refers to a surfactant that does not have a group dissociating into ions in an aqueous solution and has an —OH group.

Although having relatively little hydrophilicity, it has ester, acid amide, and ether bonds within the molecule. The nonionic surfactants include an ether type, an ester ether type, an ester type, and a nitrogen-containing type.

Examples of the ether type surfactant include alkyl and alkylaryl polyoxyethylene ethers, alkylaryl formaldehyde condensed polyoxyethylene ethers, block polymers using polyoxypropylene as a lipophilic group, and polyoxyethylene-polyoxypropylene copolymers.

The oxyacid is used to increase the dissolution stability of the metal compound in a metal salt aqueous solution.

The oxyacid is a hydroxycarboxylic acid, and specific examples thereof include, for example, citric acid, malic acid, tartaric acid, tartronic acid, glyceric acid, hydroxybutyric acid, hydroxy acrylic acid, lactic acid, and glycolic acid.

Meanwhile, it is necessary to control the coagulation between metal ingredients and increase the dispersion in order to improve the combustion aid activity. To this end, the stability of the metal salt aqueous solution may be improved to some extent by adding oxyacid to the additive, however, there is still a problem that the combustion aid ability is reduced because the coagulation between metal ingredients cannot be sufficiently controlled.

In this regard, step S40 includes an example of further adding precipitated carbonate to the additive.

A fine coating film is formed on the metal salt by adding the precipitated carbonate to increase the repulsion between the metal salts, thereby controlling the coagulation phenomenon.

Preferably, it is reasonable that the metal salt and precipitated carbonate may be stored as a mixture and added as a mixture to form an aqueous solution, so as to prevent a agglomeration phenomenon between particles during storage.

The precipitated carbonate includes precipitated crystalline and/or amorphous carbonate compounds as metastable carbonate compounds precipitated from water, such as alkaline earth metal-containing water like brine.

The combustion aid mixes the above composition and then precipitates and stabilizes the mixed composition for a certain period of time without separating and drying the precipitate, and may be used as a solid combustion aid added during combustion when the precipitate is separated and dried. In addition, the liquid composition remaining after separating the precipitate may be used as a liquid combustion aid.

Meanwhile, the desulfurization catalyst prepared in step S30 may be used as a liquid desulfurization catalyst, and combustible materials such as coal may be impregnated into the liquid desulfurization catalyst, so that the combustible materials having surfaces reformed by the desulfurization catalyst may be applied.

In other words, the combustible materials such as coal may be immersed in the liquid desulfurization catalyst to combust the reformed combustible materials, so that uniform desulfurization may be achieved.

When a desulfurization catalyst is introduced separately from the combustible materials, a predetermined configuration may be required to allow the desulfurization catalyst to be uniformly sprayed. However, when the combustible materials having surfaces reformed by the desulfurization catalyst is applied as described above, uniform desulfurization efficiency may be expected.

An example is presented in which the liquid desulfurization catalyst further includes hydroxylpropyl methylcellulose-based powder when the surfaces of the combustible materials are reformed by the desulfurization catalyst.

The hydroxylpropyl methyl cellulose-based powder is added to the liquid desulfurization catalyst to impart viscosity, so that the desulfurization catalyst ingredients among the liquid desulfurization catalysts are easily attached to the surfaces of the combustible materials, thereby facilitating the reforming and a gel network is destroyed upon combustion to prevent a thickening effect from being expressed, and accordingly, the desulfurization catalyst ingredients is easily detached from the combustible materials to increase the surface area for desulfurization, thereby increasing the desulfurization efficiency.

In the case of hydroxylpropyl methylcellulose-based powder, the gel network is destroyed even by low-temperature heating, so that the desulfurization catalyst is detached from the combustible materials from the beginning of combustion, thereby doubling the desulfurization efficiency.

In particular, the hydroxylpropyl methyl cellulose-based powder, unlike general methyl cellulose (MC), is obtained by introducing a water-soluble polymer into methyl cellulose (MC). The thickening effect may not be immediately exhibited when the composition is mixed and the thickening effect may be exhibited by methyl cellulose (MC) after the water-soluble polymer has dissolved, and thus the exhibition of thickening effect may be slightly delayed.

In other words, the hydroxylpropyl methyl cellulose-based powder provides stirring time for allowing compositions to be uniformly mixed, so that viscosity is developed after the compositions is sufficiently mixed, thereby achieving the uniform reforming.

Hereinafter, preferred embodiments of the present invention will be described based on experimental examples.

### Example 1

First, 1,350 g of yellow-state illite crushed to 1,000 mesh is added to 15 L of RO water heated to 60° C. and is stirred for 30 minutes.

Thereafter, 150 g of sodium tetraborate is added and stirred for 10 minutes to dissolve sufficiently (the temperature drops by approximately 10° C.), and then 300 g of sodium hydroxide is slowly added and stirred. When the temperature of the reaction solution reaches 70° C. by dilution heat, 300 g of water glass is added and stirred for 1 hour. The reaction solution is stirred until the temperature naturally decreases to room temperature.

The stirring is stopped at room temperature, the reaction solution is placed overnight, and the supernatant is filtered to prepare a desulfurization catalyst. In addition, the precipitate is separated to prepare a combustion aid.

### Exhaust Gas Analysis Equipment

NOVA 9K (MRU Emission Monitoring System, Germany) is used, and the sensors, measurement ranges, and resolutions for each target to be measured are as shown below.
O₂(E.C): 0~21 Vol %/0.2%
CO₂(NDIR): 0~40 Vol %/0.3%
SO₂(E.C): 0~2,000 ppm/5 ppm
EC: Electrochemical sensor, NDIR: Non-dispersive infrared sensor

### Exhaust Gas Analysis Scheme

SO₂ analysis

The charcoal briquette is put in the Meseta Harry wood-burning stove and ignited, 1 kg of brown coal is added 5 minutes later and combustion begins.

After about 15 minutes, 3 kg of brown coal, to which 100 g of the liquid desulfurization catalyst prepared in Example 1 is uniformly sprayed, is added and combustion begins fully.

In order to absorb some of the exhaust gas exhausted through a chimney, a hole is drilled in a middle part of the chimney and connected with a silicone hose, and a gap is completely sealed by silicone. Exhaust gas is sucked through a diaphragm pump to adjust a flow meter to 35 L/min, and blown into a reaction tank among experimental devices through an In-Let tube of a gas trap adapter.

The exhaust gas discharged through an Out-Let tube of the gas trap adapter is connected to NOVA 9K and then an amount of SO₂ is measured.
CO₂ analysis

First, 3 kg of brown coal (Series 2) is placed on the Meseta Harry wood-burning stove and combusted, and 100 g of the combustion aid prepared in Example 1 is mixed with 3 kg of brown coal (Series 1) and combusted.

Thereafter, in order to absorb some of the exhaust gas exhausted through a chimney, a hole is drilled in a middle part of the chimney and connected with a silicone hose, and a gap is completely sealed by silicone. Exhaust gas is sucked through a diaphragm pump to adjust a flow meter to 35 L/min, and blown into a reaction tank among experimental devices through an In-Let tube of a gas trap adapter.

The exhaust gas discharged through an Out-Let tube of the gas trap adapter is connected to NOVA 9K and then an amount of CO₂ is measured, respectively.

### <Experimental Example 1>Measurement on SOx Removal Ability

After brown coal is combusted in the wood-burning stove, the generated amount of SOx is measured and the reduced amount of SOx is measured in the exhaust gas using the experimental devices.

The experimental result is shown in FIG. 2. As shown in the graph, it can be seen that the SOx reduction ability is exhibited by the action of the desulfurization catalyst of Example 1 from approximately 37 minutes to 91 minutes.

### <Experimental Example 2> Measurement on CO₂ Concentration

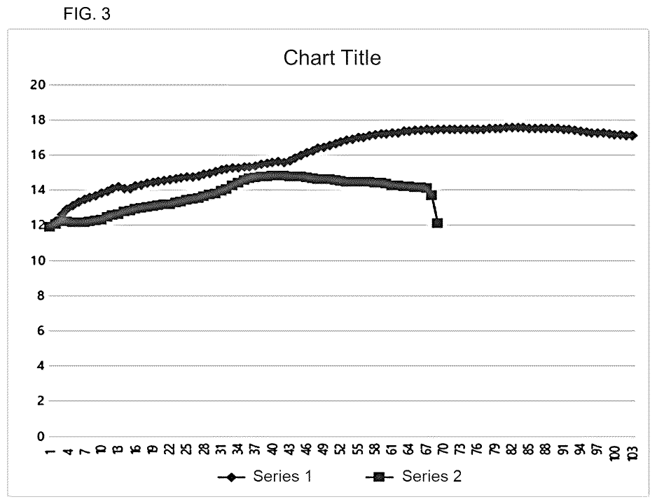

The experimental result is shown in FIG. 3, and it can be seen that the generated amount of CO₂ in the exhaust gas increases from 14% (Series 2) to 17% (Series 1). In other words, it can be seen that the combustion efficiency is improved by 20% by further adding the combustion aid of the present invention to the fuel before combustion. As described above, although the present invention has been described by the limited embodiments and drawings, the present invention is not limited to the embodiments, and it will be understood by a person having ordinary skill in the art that various changes and modifications may be carried out from the above-mentioned description.

1. A method for manufacturing a combustion aid added before fossil fuel combustion and a desulfurization catalyst, the method comprising:
(S10) introducing an illite powder into a reaction tank storing water heated to 40° C. to 100° C., followed by stirring;
(S20) introducing sodium hydroxide into the reaction tank, followed by stirring;
(S30) preparing a desulfurization catalyst by separating and filtering a supernatant in the reaction tank; and
(S40) preparing a combustion aid by separating a precipitate from the reaction tank.

2. The of claim 1, wherein step S20 includes adding sodium tetraborate to the reaction tank.

3. The method of claim 2, wherein step S20 includes adding water glass to the reaction tank.

4. The method of claim 3, wherein step S20 includes adding hydrogen peroxide to the reaction tank.

5. The method of claim 1, wherein step S40 includes mixing an additive including a surfactant and an oxyacid into the combustion aid.

6. The method of claim 5, wherein step S40 includes mixing precipitated carbonate into the combustion aid.

7. The method of claim 1, wherein step S30 includes adding hydroxylpropyl methyl cellulose-based powder to a desulfurization catalyst.
